(19) United States
(12) Patent Application Publication
(10) Pub. No.: US 2016/0379630 A1
(43) Pub. Date: Dec. 29, 2016

(54) SPEECH RECOGNITION SERVICES

(71) Applicant: Intel Corporation, Santa Clara, CA (US)

(72) Inventors: Michel Assayag, Shoham (IL); Moshe Wasserblat, Maccabim (IL); Oren Pereg, Amikam (IL); Shahar Taite, Kfar Saba (IL); Alexander Sivak, Haifa (IL); Tomer Rider, Naahryia (IL)

(73) Assignee: Intel Corporation, Santa Clara, CA (US)

(21) Appl. No.: 14/750,757

(22) Filed: Jun. 25, 2015

(51) Int. Cl. G10L 15/22; G10L 15/01; G10L 15/26; G10L 15/06; G10L 15/30

(52) U.S. Cl. CPC G10L 15/22; G10L 15/063; G10L 15/30; G10L 15/265; G10L 15/01; G10L 2015/227; G10L 2015/223; G10L 2015/0638; G10L 2015/088

(57) ABSTRACT

Various systems and methods for providing speech recognition services are described herein. A user device for providing speech recognition services includes a speech module to maintain a speech recognition model of a user of the user device; a user interaction module to detect an initiation of an interaction between the user and a target device; and a transmission module to transmit the speech recognition model to the target device, the target device to use the speech recognition model to enhance a speech recognition process executed by the target device during the interaction between the user and the target device.

### TECHNICAL FIELD

Embodiments described herein generally relate to speech and voice recognition and in particular, to a system for providing speech recognition services.

### BACKGROUND

Speech recognition, also referred to as automatic speech recognition (ASR), is the translation of spoken words into text. Speech recognition is widely used in consumer devices, security systems, vehicles, telephony, and technologies. Speech recognition is useful, for example, when a person is otherwise occupied with their hands and unable to type, or when a person is incapable of using a keyboard or other manual input device due to a disability.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a block diagram illustrating the phases of operation, according to an embodiment;

FIG. 3 is a flowchart illustrating control and data flow during operation, according to an embodiment;

FIG. 4 is a block diagram illustrating a user device for providing speech recognition services, according to an embodiment;

FIG. 5 is a flowchart illustrating a method of providing speech recognition services, according to an embodiment; and

FIG. 6 is a block diagram illustrating an example machine upon which any one or more of the techniques (e.g., methodologies) discussed herein may perform, according to an example embodiment.

### DETAILED DESCRIPTION

Systems and methods described herein provide a system for speech recognition services. Speech recognition (SR), otherwise referred to as automatic speech recognition (ASR) is a mechanism to translate spoken words to text. ASR systems typically use some training mechanism. For example, a user may be asked to read a passage of words or sounds to train the ASR engine. The ASR engine may then analyze the user's specific voice and adjust a voice model to better fit the user's speech. Alternatively, an ASR engine may be configured to continually adjust a user's voice model over time, such as by user feedback. For example, when a user dictates an email to a friend, as the text appears in the email, the user may manually change some of the text (e.g., type a replacement or correction). The adjustments may be registered and used to make the user's voice model more accurate.

Some ASR systems do not use training. Such systems are called “speaker independent” systems. These speaker independent systems are typically not as accurate as “speaker dependent” system (those that use training). However, speaker independent systems have an advantage of not needing a training session.

The present disclosure discusses an improvement to the operation of speech recognition systems. An ASR system may be initially used to build a personal model for a user. The personal model may include acoustic and language model information. The personal model may then be stored at a cloud server or a portable user device. When the user approaches a new system equipped with an untrained ASR, the user may download or provide access to the personal model such that the untrained ASR may then recognize the user's voice with the same or similar accuracy as that of the initial (trained) ASR system. Other features are discussed in further detail below.

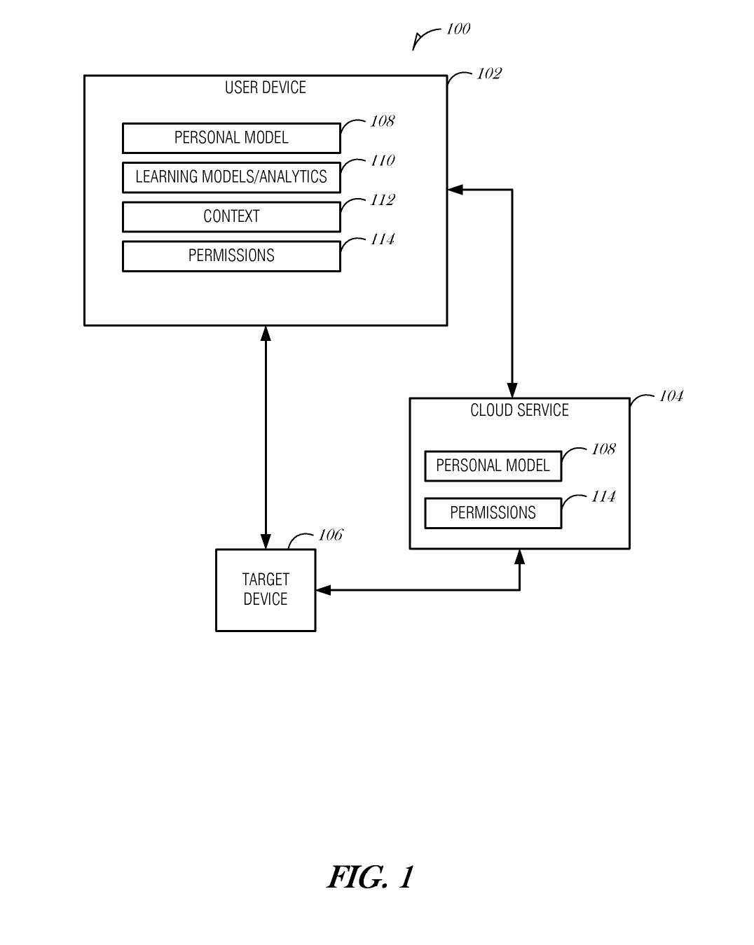

FIG. 1 is a diagram illustrating an operating environment 100, according to an embodiment. FIG. 1 includes a user device 102, an optional cloud service 104, and a target device 106. The user device 102 may be any type of compute device, including but not limited to an onboard vehicle system, set-top box, wearable device, personal computer (PC), a tablet PC, a hybrid tablet, a personal digital assistant (PDA), a mobile telephone, or the like. The user device 102 is used to develop and store a personal model 108 using various learning models or analytics 110. The personal model 108 includes acoustic and language model information. An acoustic model is used in an ASR system to represent the relationship between an audio signal and the phonemes or other linguistic units that make up speech. The acoustic model may be developed over time using audio recordings and their transcriptions to create statistical representations of the sounds that make up each word. A language model assigns a probability to a sequence of words using a probability distribution. The language model provides a practice way to estimate the likelihood of different phrases.

The learning models or analytics 110 may include one or more speech recognition algorithms, such as the Hidden Markov Model (HMM), dynamic time warping (DTW), neural networks (NN), or deep neural networks (DNN). The learning models or analytics 110 may produce one or more personal models 108 for the user. Additionally, the user device 102 may develop and store personal models 108 for more than one user.

The user device 102 may determine context 112 and store permissions 114. The context 112 may be determined using various inputs such as the location of the user device 102, the user's schedule, the operational mode of the user device 102, the local time, date, or weather, or other contextual data. Permissions 114 may be user-defined. Permissions 114 are used by the user device 102 to determine with whom or which systems the personal model 108 may be shared. The permissions 114 may also indicate limits on sharing privileges, expiration of sharing privileges, or other aspects of security with respect to the personal model 108.

Based on the context 112 and permissions 114, the user device 102 may provide the personal model 108 to the cloud service 104 or the target device 106. The cloud service 104 may be used to store the personal model 108 and the permission 114. When a user wants to access a target device 106, the user may direct the target device 106 to acquire the personal model 108 from the cloud service 104. Alternatively, some target devices 106 may be associated with a particular cloud service 104, in which case the user has to have previously provided the personal model 108 to the particular cloud service 104.

The target device 106 may be various types of devices of systems with which the user interacts. Examples of target devices 106 include, but are not limited to an onboard system in a rental vehicle, a vending machine, a conference room bridge system, home automation devices, or home entertainment devices. The types may be detected and used to determine the context of the interaction, adjust the personal model 108 used in an interaction, or set permissions of an interaction.

Various interactions may be provided between the user and the target device 106. For example, when a user approaches the target device 106 (e.g., a vending machine), the user device 102 may detect the presence of the target device 106 and authenticate the target device 106. When the user accesses the target device 106, such as by sliding their access card, entering a person identification number (PIN), or some other access method, the target device 106 may initiate a process to obtain a personal model 108. For example, the target device 106 may query the user on a display asking whether the user wishes to interact with voice commands. If the user answers in the affirmative, then the target device 106 may request a personal model 108 from the user device 102. The user device 102 may prompt the user for permission to transmit the personal model 108 to the requesting device (the target device 106). Alternatively, based on context 112 and/or permissions 114, the user device 102 may automatically provide the personal model 108 to the target device 106.

After the personal model 108 is loaded on the target device 106, the target device 106 is able to initialize its speech recognition software with the personal model 108 and provide a better user experience. The target device 106 may optionally revise the personal model 108 as the user interacts. Such revision may be allowed based on user preferences.

The user device 102 may translate the personal model 108 from a first format to a second format in order to convert the personal model to a format compatible with the target device 106. The conversion may be performed just before the interaction or there may be several formats stored at the user device 102 (or cloud service 104) to streamline interactions.

After the user has completed the transaction with the target device 106, the personal model 108 may be removed. The action taken by the target device 106 after the interaction has been completed may be determined by the permissions 114. If the target device 106 revised the personal model 108, then the target device 106 may transmit a revised personal model back to the user device 102 (or cloud service 104) to update the personal model 108.

The target device 106 may optionally obtain the personal model 108 from the cloud service 104. The cloud service 104 may communicate with the user device 102 to confirm that the personal model 108 is to be communicated to the target device 106. Alternatively, based on permissions 114 the cloud service 104 may automatically provide the personal model 108 to the target device 106.

The personal model 108 may be customized based on the context 112 or permissions 114. For example, when the user is interacting with a vending machine as the target device 106, the personal model 108 may be constrained to a smaller data set including words and phrases that are more likely to occur during a vending machine transaction. The target device 106 may provide a list of words to the user device 102 (or cloud service 104) that define commonly used words or phrases. In a vending machine transaction, for example, the target device 106 may provide key words/phrases of “select,” “change,” “vend,” and the numbers from zero to one hundred. In a rental car interaction, as another example, the target device 106 may provide phrases like “turn radio on,” “answer phone,” or “mute music.”

As another example use case, a user may participate in an international conference call. To assist the participants on the call, each speaker's words are translated to text in the native language of the reader. Before the meeting, participants may upload a personal model 108 to the target device 106 (e.g., conference bridge system) to quickly train the target device 106. After the conference call is concluded, the personal models 108 of the participants may be retained for a later use or deleted, based on permissions 114 for each personal model 108.

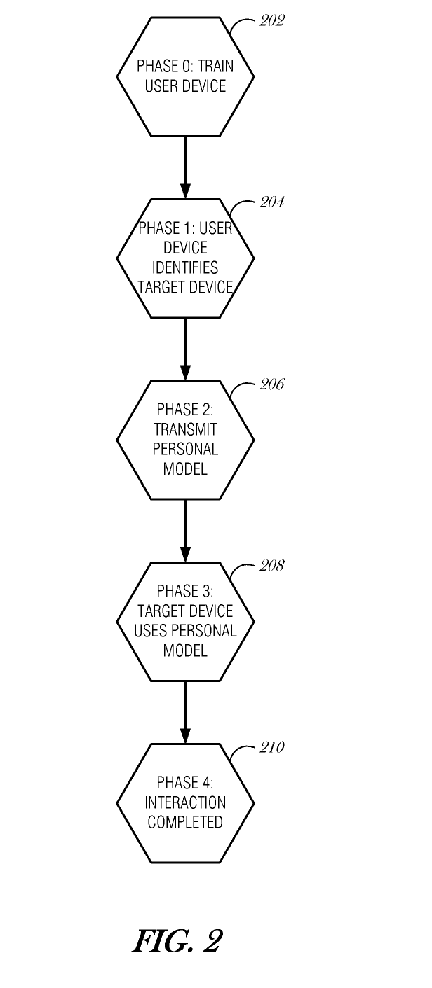

FIG. 2 is a block diagram illustrating the phases of operation, according to an embodiment. In Phase 0 (item 202), the user device is trained. Various applications and tools may be used to create an ASR model. The user may create the ASR model using a canned script or with a feedback mechanism to correct words that are not correctly interpreted by the user device. Other mechanisms may also be used.

In Phase 1 (item 204), when the user device identifies the proximity of a target device, such as with Bluetooth™, Wi-Fi, WiDi, near-field communications (NFC), or other wireless communication standards, the devices negotiate which models should be shared. This may be based on context, permissions, user prompts, and the like. The devices may also determine the way the models are shared, whether the models are encrypted, retention period, and other aspects of the communication. When the models are stored in a cloud service, the user device may provide an access key or other mechanism to the target device in order for the target device to access the models from the cloud.

In Phase 2 (item 206), after the devices have negotiated the communication configuration, the user device (or cloud) may transmit the models to the target device. In the case where only credentials are provided, the target device may access the cloud service to obtain the models.

In Phase 3 (item 208), the target device is now capable of understanding the user as if the target device had been trained itself. The user interacts with the target device and is understood at the accuracy level of the trained user device even if it is the first time the user has used the target device. In some cases, the target device may revise the model or models based on the user's interaction with the target device. The revised model may be transmitted back to the user device (or the cloud) in order to further refine and develop the models.

In Phase 4 (item 210), when the target device recognizes that the interaction is complete, e.g., the user steps away, logs out, or the meeting adjourns, the target device may delete the models. The deletion may be automatically performed. The deletion may be controlled by user preferences or be performed routinely without an option to not delete the model. Optionally, a deletion certificate may be provided from the target device to the user device to confirm that the target device deleted the models.

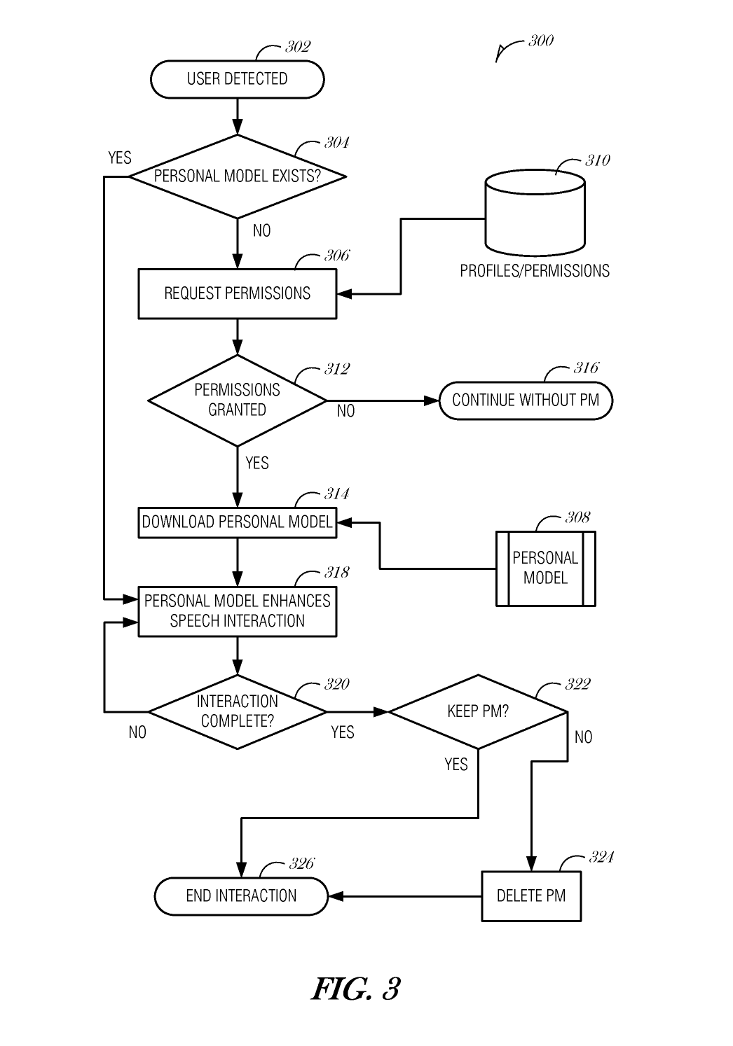

FIG. 3 is a flowchart illustrating control and data flow 300 during operation, according to an embodiment. At operation 302, a user is detected at a target device. The user may be detected using various technologies, such as Bluetooth™, radio-frequency identification (RFID), user login or authentication, when a user swipes an access card (e.g., a bank or credit card to begin a transaction), etc.

At operation 304, it is determined whether a personal model (also referred to as a “PM”) exists at the target device. The personal model for the user may exist in certain situations based on the user's preferences. For example, a vehicle that the user drives regularly may maintain a personal model for the user.

When a personal model does not exist, then at 306, permissions are requested from the user device to access the personal model. The user device stores or provides access to a personal model 308, which was created prior to the interaction. The user may have user preferences, profiles, or other access controls for a personal model 310, which include access permissions for the personal model 308. The target device may interface with the user device to determine whether the personal model 308 is to be shared with the target device. The user may be prompted on the user device to share. The user's answer may be stored for future interactions with the target device or only use for a single use. The user may be prompted for what type of access model is used (e.g., multi-use or single use) for the particular target device. For example, when the user expects to use the target device on a regular basis, the user may indicate to store the personal model at the target device for a certain time (e.g., 30 days, 1 year, or until the user expires the time).

If permissions are granted (decision block 312), then the personal model is downloaded (operation 314). Some or all of the personal model may be downloaded. For example, a subset of the personal model that is relevant to the context of the interaction may be downloaded. Downloading a subset instead of the entire personal model may reduce transmission time and load time in the target device's ASR system. If permissions are not granted at 312, then the interaction may continue with the use of the personal model (operation 316). In this case, the speech recognition is conducted without the benefit of the personalized model.

The personal model is used to enhance the speech recognition of the target device (operation 318). After the interaction has ended (decision block 320), it is determined whether to keep the personal model (decision block 322). Depending on the preferences, the personal model is deleted (operation 324) or stored for later use (operation 326). The personal model may be deleted selectively based on user preferences or other configuration parameters. The personal model may be deleted automatically or may be trigged by some user action, such as a confirmation provided by the user via a user interface to delete the personal model.

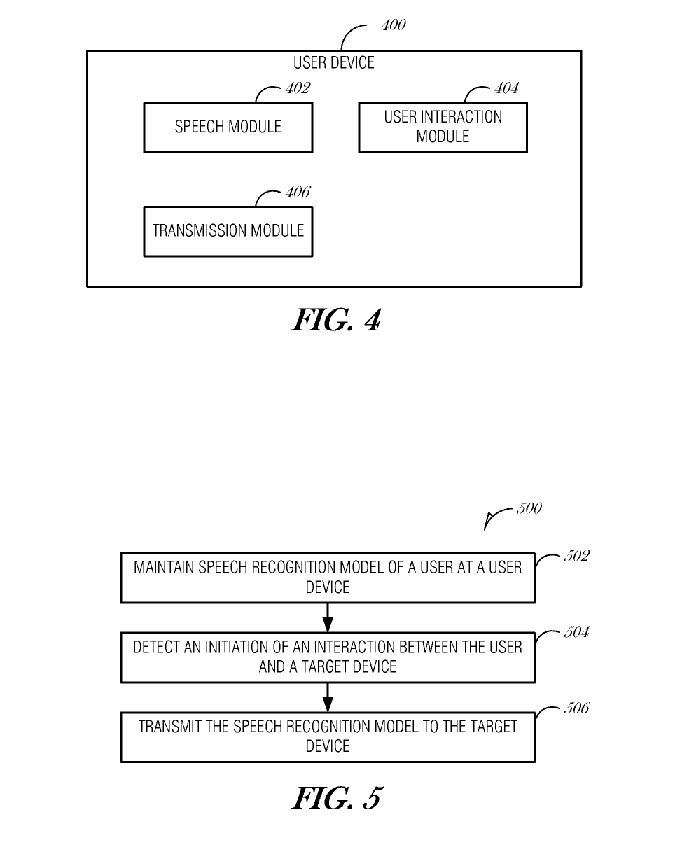

FIG. 4 is a block diagram illustrating a user device 400 for providing speech recognition services, according to an embodiment. The user device 400 includes a speech module 402, a user interaction module 404, and a transmission module 406. The speech module 402 may be configured to maintain a speech recognition model of a user of the user device. In an embodiment, the speech recognition model includes an acoustic model and a language model.

In an embodiment, to maintain the speech recognition model, the speech module 402 is to prompt the user to read a script, recognize words spoken by the user while reading the script, and correlate the words spoken by the user with words in the script.

In an embodiment, to maintain the speech recognition model, the speech module 402 is to attempt to recognize words spoken by the user while executing an application on the user device, incorporate user feedback from the user to make corrections of mistakes when translating the words spoken by the user, and revise the speech recognition model based on the corrections.

The user interaction module 404 may be configured to detect an initiation of an interaction between the user and a target device. In an embodiment, to detect the initiation of the interaction, the user interaction module is to detect the target device using a wireless network protocol, identify a user action, and correlate the user action with the target device to detect the initiation of the interaction. In a further embodiment, the user action comprises walking toward the target device. In another embodiment, the user action comprises authenticating with the target device. For example, the user may log in to a computer, kiosk, or other compute device.

The transmission module 406 may be configured to transmit the speech recognition model to the target device, the target device to use the speech recognition model to enhance a speech recognition process executed by the target device during the interaction between the user and the target device.

In an embodiment, to transmit the speech recognition model to the target device, the transmission module 406 is to encrypt the speech recognition model to produce an encrypted speech recognition model and transmit the encrypted speech recognition model to the target device. The transmission module 406 may use a symmetrical or asymmetrical encryption scheme.

In an embodiment, to transmit the speech recognition model to the target device, the transmission module 406 is to transmit a credential to the target device, the credential for a cloud-based service, where the target device uses the credential to access the cloud-based service and obtain the speech recognition model.

In an embodiment, to transmit the speech recognition model to the target device, the transmission module 406 is to identify a second format, the second format compatible with the target device, convert the speech recognition model from a first format to the second format, and transmit the speech recognition model in the second format to the target device.

In an embodiment, to transmit the speech recognition model to the target device, the transmission module 406 is to determine a type of the target device, determine a subset of the speech recognition model corresponding to the type of the target device, and transmit the subset of the speech recognition model to the target device. For example, types may be defined by a system provider (e.g., manufacturer), the user, or a third-party. The types may be generally defined or user defined. Examples types may include banking teller machines, vehicle systems, retail sales kiosks, public facilities, etc.

In an embodiment, to transmit the speech recognition model to the target device, the transmission module 406 is to determine a context of the interaction with the target device, determine a subset of the speech recognition model corresponding to the context of the interaction, and transmit the subset of the speech recognition model to the target device. The context of the interaction may be events like using a vending machine, operating a vehicle, or attending a conference call, for example. The context may be determined by analyzing the user's calendar or schedule, identifying the user's location, using image analysis and identifying the environment around the user, or by querying other proximate devices or sensors, for example.

In an embodiment, the transmission module 406 is to transmit user preferences to the target device. In a further embodiment, the user preferences comprise deletion preferences, the deletion preferences used by the target device to control a deletion operation of the speech recognition model on the target device. In an embodiment, the target device is to delete the speech recognition model. In an embodiment, the target device is to automatically delete the speech recognition model when the interaction between the user device and the target device has concluded.

In an embodiment, the user device 400 includes a permissions module to receive a request from the target device to access the speech recognition model and allow access to the speech recognition model based on permissions.

In an embodiment, the speech module 402 is to revise the speech recognition model based on the interaction between the target device and the user. For example, the target device may update the speech recognition model and communicate it back to the user device 400 during or after the interaction. In an embodiment, to revise the speech recognition model, the speech module 402 is to receive a revised speech recognition model from the target device and integrate the revised speech recognition model with the speech recognition model.

FIG. 5 is a flowchart illustrating a method 500 of providing speech recognition services, according to an embodiment. At block 502, a speech recognition model of a user of a user device is maintained at the user device. In an embodiment, the speech recognition model includes an acoustic model and a language model.

In an embodiment, maintaining the speech recognition model comprises prompting the user to read a script, recognizing words spoken by the user while reading the script, and correlating the words spoken by the user with words in the script.

In an embodiment, maintaining the speech recognition model comprises attempting to recognize words spoken by the user while executing an application on the user device, incorporating user feedback from the user to make corrections of mistakes when translating the words spoken by the user, and revising the speech recognition model based on the corrections.

At block 504, an initiation of an interaction between the user and a target device is detected. In an embodiment, detecting the initiation of the interaction comprises detecting the target device using a wireless network protocol, identifying a user action, and correlating the user action with the target device to detect the initiation of the interaction. In a further embodiment, the user action comprises walking toward the target device. In another embodiment, the user action comprises authenticating with the target device.

At block 506, the speech recognition model is transmitted to the target device, the target device to use the speech recognition model to enhance a speech recognition process executed by the target device during the interaction between the user and the target device.

In an embodiment, transmitting the speech recognition model to the target device comprises encrypting the speech recognition model to produce an encrypted speech recognition model and transmitting the encrypted speech recognition model to the target device.

In an embodiment, transmitting the speech recognition model to the target device comprises transmitting a credential to the target device, the credential for a cloud-based service, wherein the target device uses the credential to access the cloud-based service and obtain the speech recognition model.

In an embodiment, transmitting the speech recognition model to the target device comprises identifying a second format, the second format compatible with the target device, converting the speech recognition model from a first format to the second format, and transmitting the speech recognition model in the second format to the target device.

In an embodiment, transmitting the speech recognition model to the target device comprises determining a type of the target device, determining a subset of the speech recognition model corresponding to the type of the target device, and transmitting the subset of the speech recognition model to the target device.

In an embodiment, transmitting the speech recognition model to the target device comprises determining a context of the interaction with the target device, determining a subset of the speech recognition model corresponding to the context of the interaction, and transmitting the subset of the speech recognition model to the target device.

In an embodiment, the method 500 includes transmitting user preferences to the target device. In a further embodiment, the user preferences comprise deletion preferences, the deletion preferences used by the target device to control a deletion operation of the speech recognition model on the target device. In an embodiment, the target device is to delete the speech recognition model. In an embodiment, the target device is to automatically delete the speech recognition model when the interaction between the user device and the target device has concluded.

In an embodiment, the method 500 includes receiving a request from the target device to access the speech recognition model and allowing access to the speech recognition model based on permissions.

In an embodiment, the method 500 includes revising the speech recognition model based on the interaction between the target device and the user. In a further embodiment, revising the speech recognition model comprises receiving a revised speech recognition model from the target device and integrating the revised speech recognition model with the speech recognition model.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

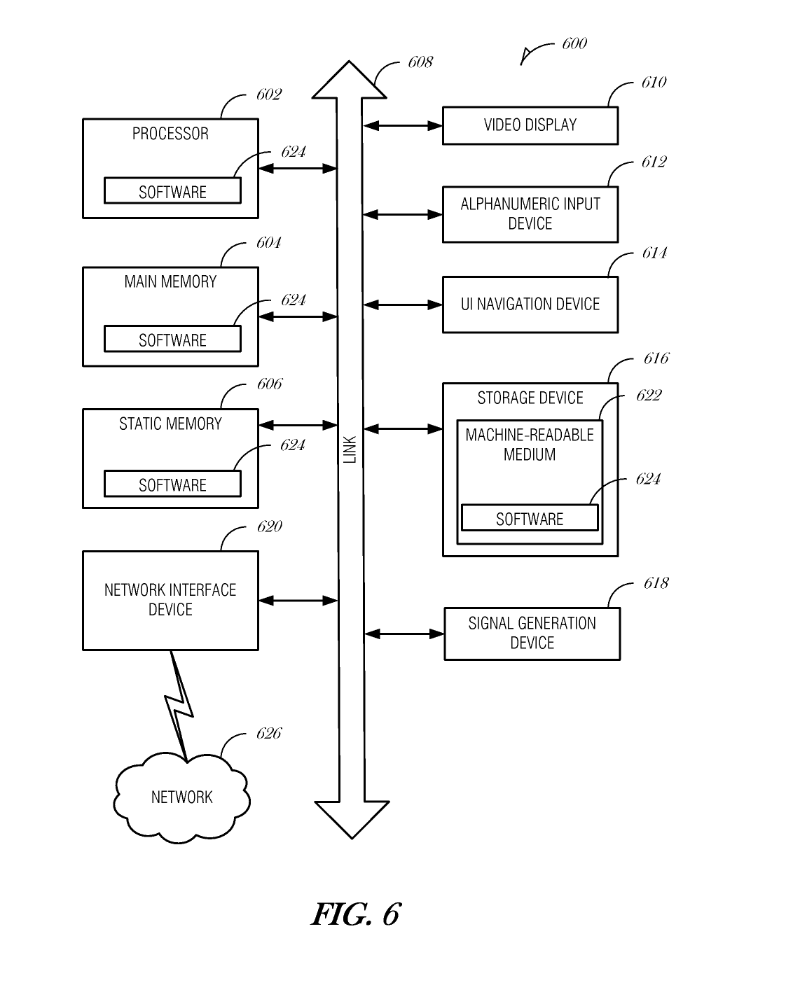

FIG. 6 is a block diagram illustrating a machine in the example form of a computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter for providing speech recognition services (such as a device, apparatus, or machine) comprising: a speech module to maintain a speech recognition model of a user of the user device; a user interaction module to detect an initiation of an interaction between the user and a target device; and a transmission module to transmit the speech recognition model to the target device, the target device to use the speech recognition model to enhance a speech recognition process executed by the target device during the interaction between the user and the target device.

In Example 2, the subject matter of Example 1 may include, wherein the speech recognition model includes an acoustic model and a language model.

In Example 3, the subject matter of any one of Examples 1 to 2 may include, wherein to maintain the speech recognition model, the speech module is to: prompt the user to read a script; recognize words spoken by the user while reading the script; and correlate the words spoken by the user with words in the script.

In Example 4, the subject matter of any one of Examples 1 to 3 may include, wherein to maintain the speech recognition model, the speech module is to: attempt to recognize words spoken by the user while executing an application on the user device; incorporate user feedback from the user to make corrections of mistakes when translating the words spoken by the user; and revise the speech recognition model based on the corrections.

In Example 5, the subject matter of any one of Examples 1 to 4 may include, wherein to detect the initiation of the interaction, the user interaction module is to: detect the target device using a wireless network protocol; identify a user action; and correlate the user action with the target device to detect the initiation of the interaction.

In Example 6, the subject matter of any one of Examples 1 to 5 may include, wherein the user action comprises walking toward the target device.

In Example 7, the subject matter of any one of Examples 1 to 6 may include, wherein the user action comprises authenticating with the target device.

In Example 8, the subject matter of any one of Examples 1 to 7 may include, wherein to transmit the speech recognition model to the target device, the transmission module is to: encrypt the speech recognition model to produce an encrypted speech recognition model; and transmit the encrypted speech recognition model to the target device.

In Example 9, the subject matter of any one of Examples 1 to 8 may include, wherein to transmit the speech recognition model to the target device, the transmission module is to: transmit a credential to the target device, the credential for a cloud-based service, wherein the target device uses the credential to access the cloud-based service and obtain the speech recognition model.

In Example 10, the subject matter of any one of Examples 1 to 9 may include, wherein to transmit the speech recognition model to the target device, the transmission module is to: identify a second format, the second format compatible with the target device; convert the speech recognition model from a first format to the second format; and transmit the speech recognition model in the second format to the target device.

In Example 11, the subject matter of any one of Examples 1 to 10 may include, wherein to transmit the speech recognition model to the target device, the transmission module is to: determine a type of the target device; determine a subset of the speech recognition model corresponding to the type of the target device; and transmit the subset of the speech recognition model to the target device.

In Example 12, the subject matter of any one of Examples 1 to 11 may include, wherein to transmit the speech recognition model to the target device, the transmission module is to: determine a context of the interaction with the target device; determine a subset of the speech recognition model corresponding to the context of the interaction; and transmit the subset of the speech recognition model to the target device.

In Example 13, the subject matter of any one of Examples 1 to 12 may include, wherein the transmission module is to transmit user preferences to the target device.

In Example 14, the subject matter of any one of Examples 1 to 13 may include, wherein the user preferences comprise deletion preferences, the deletion preferences used by the target device to control a deletion operation of the speech recognition model on the target device.

In Example 15, the subject matter of any one of Examples 1 to 14 may include, wherein the target device is to delete the speech recognition model.

In Example 16, the subject matter of any one of Examples 1 to 15 may include, wherein the target device is to automatically delete the speech recognition model when the interaction between the user device and the target device has concluded.

In Example 17, the subject matter of any one of Examples 1 to 16 may include, a permissions module to: receive a request from the target device to access the speech recognition model; and allow access to the speech recognition model based on permissions.

In Example 18, the subject matter of any one of Examples 1 to 17 may include, wherein the speech module is to: revise the speech recognition model based on the interaction between the target device and the user.

In Example 19, the subject matter of any one of Examples 1 to 18 may include, wherein to revise the speech recognition model, the speech module is to: receive a revised speech recognition model from the target device; and integrate the revised speech recognition model with the speech recognition model.

Example 20 includes subject matter for providing speech recognition services (such as a method, means for performing acts, machine readable medium including instructions that when performed by a machine cause the machine to performs acts, or an apparatus to perform) comprising: maintaining, at a user device, a speech recognition model of a user of the user device; detecting an initiation of an interaction between the user and a target device; and transmitting the speech recognition model to the target device, the target device to use the speech recognition model to enhance a speech recognition process executed by the target device during the interaction between the user and the target device.

In Example 21, the subject matter of Example 20 may include, wherein the speech recognition model includes an acoustic model and a language model.

In Example 22, the subject matter of any one of Examples 20 to 21 may include, wherein maintaining the speech recognition model comprises: prompting the user to read a script; recognizing words spoken by the user while reading the script; and correlating the words spoken by the user with words in the script.

In Example 23, the subject matter of any one of Examples 20 to 22 may include, wherein maintaining the speech recognition model comprises: attempting to recognize words spoken by the user while executing an application on the user device; incorporating user feedback from the user to make corrections of mistakes when translating the words spoken by the user; and revising the speech recognition model based on the corrections.

In Example 24, the subject matter of any one of Examples 20 to 23 may include, wherein detecting the initiation of the interaction comprises: detecting the target device using a wireless network protocol; identifying a user action; and correlating the user action with the target device to detect the initiation of the interaction.

In Example 25, the subject matter of any one of Examples 20 to 24 may include, wherein the user action comprises walking toward the target device.

In Example 26, the subject matter of any one of Examples 20 to 25 may include, wherein the user action comprises authenticating with the target device.

In Example 27, the subject matter of any one of Examples 20 to 26 may include, wherein transmitting the speech recognition model to the target device comprises: encrypting the speech recognition model to produce an encrypted speech recognition model; and transmitting the encrypted speech recognition model to the target device.

In Example 28, the subject matter of any one of Examples 20 to 27 may include, wherein transmitting the speech recognition model to the target device comprises: transmitting a credential to the target device, the credential for a cloud-based service, wherein the target device uses the credential to access the cloud-based service and obtain the speech recognition model.

In Example 29, the subject matter of any one of Examples 20 to 28 may include, wherein transmitting the speech recognition model to the target device comprises: identifying a second format, the second format compatible with the target device; converting the speech recognition model from a first format to the second format; and transmitting the speech recognition model in the second format to the target device.

In Example 30, the subject matter of any one of Examples 20 to 29 may include, wherein transmitting the speech recognition model to the target device comprises: determining a type of the target device; determining a subset of the speech recognition model corresponding to the type of the target device; and transmitting the subset of the speech recognition model to the target device.

In Example 31, the subject matter of any one of Examples 20 to 30 may include, wherein transmitting the speech recognition model to the target device comprises: determining a context of the interaction with the target device; determining a subset of the speech recognition model corresponding to the context of the interaction; and transmitting the subset of the speech recognition model to the target device.

In Example 32, the subject matter of any one of Examples 20 to 31 may include, transmitting user preferences to the target device.

In Example 33, the subject matter of any one of Examples 20 to 32 may include, wherein the user preferences comprise deletion preferences, the deletion preferences used by the target device to control a deletion operation of the speech recognition model on the target device.

In Example 34, the subject matter of any one of Examples 20 to 33 may include, wherein the target device is to delete the speech recognition model.

In Example 35, the subject matter of any one of Examples 20 to 34 may include, wherein the target device is to automatically delete the speech recognition model when the interaction between the user device and the target device has concluded.

In Example 36, the subject matter of any one of Examples 20 to 35 may include, receiving a request from the target device to access the speech recognition model; and allowing access to the speech recognition model based on permissions.

In Example 37, the subject matter of any one of Examples 20 to 36 may include, revising the speech recognition model based on the interaction between the target device and the user.

In Example 38, the subject matter of any one of Examples 20 to 37 may include, wherein revising the speech recognition model comprises: receiving a revised speech recognition model from the target device; and integrating the revised speech recognition model with the speech recognition model.

Example 39 includes at least one machine-readable medium including instructions, which when executed by a machine, cause the machine to perform operations of any of the Examples 20-38.

Example 40 includes an apparatus comprising means for performing any of the Examples 20-38.

Example 41 includes subject matter for providing speech recognition services (such as a device, apparatus, or machine) comprising: means for maintaining, at a user device, a speech recognition model of a user of the user device; means for detecting an initiation of an interaction between the user and a target device; and means for transmitting the speech recognition model to the target device, the target device to use the speech recognition model to enhance a speech recognition process executed by the target device during the interaction between the user and the target device.

In Example 42, the subject matter of Example 41 may include, wherein the speech recognition model includes an acoustic model and a language model.

In Example 43, the subject matter of any one of Examples 41 to 42 may include, wherein the means for maintaining the speech recognition model comprise: means for prompting the user to read a script; means for recognizing words spoken by the user while reading the script; and means for correlating the words spoken by the user with words in the script.

In Example 44, the subject matter of any one of Examples 41 to 43 may include, wherein the means for maintaining the speech recognition model comprise: means for attempting to recognize words spoken by the user while executing an application on the user device; means for incorporating user feedback from the user to make corrections of mistakes when translating the words spoken by the user; and means for revising the speech recognition model based on the corrections.

In Example 45, the subject matter of any one of Examples 41 to 44 may include, wherein the means for detecting the initiation of the interaction comprise: means for detecting the target device using a wireless network protocol; means for identifying a user action; and means for correlating the user action with the target device to detect the initiation of the interaction.

In Example 46, the subject matter of any one of Examples 41 to 45 may include, wherein the user action comprises walking toward the target device.

In Example 47, the subject matter of any one of Examples 41 to 46 may include, wherein the user action comprises authenticating with the target device.

In Example 48, the subject matter of any one of Examples 41 to 47 may include, wherein the means for transmitting the speech recognition model to the target device comprise: means for encrypting the speech recognition model to produce an encrypted speech recognition model; and means for transmitting the encrypted speech recognition model to the target device.

In Example 49, the subject matter of any one of Examples 41 to 48 may include, wherein the means for transmitting the speech recognition model to the target device comprise: means for transmitting a credential to the target device, the credential for a cloud-based service, wherein the target device uses the credential to access the cloud-based service and obtain the speech recognition model.

In Example 50, the subject matter of any one of Examples 41 to 49 may include, wherein the means for transmitting the speech recognition model to the target device comprise: means for identifying a second format, the second format compatible with the target device; means for converting the speech recognition model from a first format to the second format; and means for transmitting the speech recognition model in the second format to the target device.

In Example 51, the subject matter of any one of Examples 41 to 50 may include, wherein the means for transmitting the speech recognition model to the target device comprise: means for determining a type of the target device; means for determining a subset of the speech recognition model corresponding to the type of the target device; and means for transmitting the subset of the speech recognition model to the target device.

In Example 52, the subject matter of any one of Examples 41 to 51 may include, wherein the means for transmitting the speech recognition model to the target device comprise: means for determining a context of the interaction with the target device; means for determining a subset of the speech recognition model corresponding to the context of the interaction; and means for transmitting the subset of the speech recognition model to the target device.

In Example 53, the subject matter of any one of Examples 41 to 52 may include, means for transmitting user preferences to the target device.

In Example 54, the subject matter of any one of Examples 41 to 53 may include, wherein the user preferences comprise deletion preferences, the deletion preferences used by the target device to control a deletion operation of the speech recognition model on the target device.

In Example 55, the subject matter of any one of Examples 41 to 54 may include, wherein the target device is to delete the speech recognition model.

In Example 56, the subject matter of any one of Examples 41 to 55 may include, wherein the target device is to automatically delete the speech recognition model when the interaction between the user device and the target device has concluded.

In Example 57, the subject matter of any one of Examples 41 to 56 may include, means for receiving a request from the target device to access the speech recognition model; and means for allowing access to the speech recognition model based on permissions.

In Example 58, the subject matter of any one of Examples 41 to 57 may include, means for revising the speech recognition model based on the interaction between the target device and the user.

In Example 59, the subject matter of any one of Examples 41 to 58 may include, wherein the means for revising the speech recognition model comprise: means for receiving a revised speech recognition model from the target device; and means for integrating the revised speech recognition model with the speech recognition model.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A user device for providing speech recognition services, the user device comprising:
a speech module to maintain a speech recognition model of a user of the user device;
a user interaction module to detect an initiation of an interaction between the user and a target device; and
a transmission module to transmit the speech recognition model to the target device, the target device to use the speech recognition model to enhance a speech recognition process executed by the target device during the interaction between the user and the target device.

2. The user device of claim 1, wherein the speech recognition model includes an acoustic model and a language model.

3. The user device of claim 1, wherein to maintain the speech recognition model, the speech module is to:
prompt the user to read a script;
recognize words spoken by the user while reading the script; and
correlate the words spoken by the user with words in the script.

4. The user device of claim 1, wherein to maintain the speech recognition model, the speech module is to:
attempt to recognize words spoken by the user while executing an application on the user device;
incorporate user feedback from the user to make corrections of mistakes when translating the words spoken by the user; and
revise the speech recognition model based on the corrections.

5. The user device of claim 1, wherein to detect the initiation of the interaction, the user interaction module is to:
detect the target device using a wireless network protocol;
identify a user action; and
correlate the user action with the target device to detect the initiation of the interaction.

6. The user device of claim 5, wherein the user action comprises walking toward the target device.

7. The user device of claim 5, wherein the user action comprises authenticating with the target device.

8. The user device of claim 1, wherein to transmit the speech recognition model to the target device, the transmission module is to:
encrypt the speech recognition model to produce an encrypted speech recognition model; and
transmit the encrypted speech recognition model to the target device.

9. The user device of claim 1, wherein to transmit the speech recognition model to the target device, the transmission module is to:
transmit a credential to the target device, the credential for a cloud-based service, wherein the target device uses the credential to access the cloud-based service and obtain the speech recognition model.

10. The user device of claim 1, wherein to transmit the speech recognition model to the target device, the transmission module is to:
identify a second format, the second format compatible with the target device;
convert the speech recognition model from a first format to the second format; and
transmit the speech recognition model in the second format to the target device.

11. The user device of claim 1, wherein the target device is to delete the speech recognition model.

12. The user device of claim 11, wherein the target device is to automatically delete the speech recognition model when the interaction between the user device and the target device has concluded.

13. At least one machine-readable medium including instructions for providing speech recognition services, which when executed by a machine, cause the machine to:
maintain, at a user device, a speech recognition model of a user of the user device;
detect an initiation of an interaction between the user and a target device; and
transmit the speech recognition model to the target device, the target device to use the speech recognition model to enhance a speech recognition process executed by the target device during the interaction between the user and the target device.

14. The at least one machine-readable medium of claim 13, wherein the instructions to maintain the speech recognition model comprise instructions to:
attempting to recognize words spoken by the user while executing an application on the user device;
incorporate user feedback from the user to make corrections of mistakes when translating the words spoken by the user; and
revise the speech recognition model based on the corrections.

15. The at least one machine-readable medium of claim 13, wherein the instructions to detect the initiation of the interaction comprise instructions to:
detect the target device using a wireless network protocol;
identify a user action; and
correlate the user action with the target device to detect the initiation of the interaction.

16. The at least one machine-readable medium of claim 13, wherein the instructions to transmit the speech recognition model to the target device comprise instructions to:
encrypt the speech recognition model to produce an encrypted speech recognition model; and
transmit the encrypted speech recognition model to the target device.

17. The at least one machine-readable medium of claim 13, wherein the instructions to transmit the speech recognition model to the target device comprise instructions to:
transmit a credential to the target device, the credential for a cloud-based service, wherein the target device uses the credential to access the cloud-based service and obtain the speech recognition model.

18. The at least one machine-readable medium of claim 13, wherein the instructions to transmit the speech recognition model to the target device comprise instructions to:
identify a second format, the second format compatible with the target device;
convert the speech recognition model from a first format to the second format; and
transmit the speech recognition model in the second format to the target device.

19. The at least one machine-readable medium of claim 13, wherein the instructions to transmit the speech recognition model to the target device comprise instructions to:
determine a type of the target device;
determine a subset of the speech recognition model corresponding to the type of the target device; and
transmit the subset of the speech recognition model to the target device.

20. The at least one machine-readable medium of claim 13, wherein the instructions to transmit the speech recognition model to the target device comprise instructions to:
determine a context of the interaction with the target device;
determine a subset of the speech recognition model corresponding to the context of the interaction; and
transmit the subset of the speech recognition model to the target device.

21. A method of providing speech recognition services, the method comprising:
maintaining, at a user device, a speech recognition model of a user of the user device;
detecting an initiation of an interaction between the user and a target device; and
transmitting the speech recognition model to the target device, the target device to use the speech recognition model to enhance a speech recognition process executed by the target device during the interaction between the user and the target device.

22. The method of claim 21, wherein detecting the initiation of the interaction comprises:
detecting the target device using a wireless network protocol;
identifying a user action; and
correlating the user action with the target device to detect the initiation of the interaction.

23. The method of claim 21, wherein transmitting the speech recognition model to the target device comprises:
encrypting the speech recognition model to produce an encrypted speech recognition model; and
transmitting the encrypted speech recognition model to the target device.

24. The method of claim 21, wherein transmitting the speech recognition model to the target device comprises:
transmitting a credential to the target device, the credential for a cloud-based service, wherein the target device uses the credential to access the cloud-based service and obtain the speech recognition model.

25. The method of claim 21, wherein transmitting the speech recognition model to the target device comprises:
identifying a second format, the second format compatible with the target device;
converting the speech recognition model from a first format to the second format; and
transmitting the speech recognition model in the second format to the target device.
